(19) United States
(12) Patent Application Publication
(10) Pub. No.: US 2026/0120237 A1
(43) Pub. Date: Apr. 30, 2026

(54) ARCHITECTURE-AWARE IMAGE TILING FOR PROCESSING PATHOLOGY SLIDES

(71) Applicant: Ventana Medical Systems, Inc., Tucson, AZ (US)

(72) Inventors: Mohammad Saleh Miri, San Jose, CA (US); Karel Zuiderveld, Boulder, CO (US)

(73) Assignee: Ventana Medical Systems, Inc., Tucson, AZ (US)

(21) Appl. No.: 19/003,361

(22) Filed: Dec. 27, 2024

Related U.S. Application Data
(63) Continuation of application No. PCT/US2023/028742, filed on Jul. 26, 2023.
(60) Provisional application No. 63/392,346, filed on Jul. 26, 2022.

(51) Int. Cl. G06T 3/4046; G06T 7/13

(52) U.S. Cl. CPC G06T 3/4046; G06T 7/13; G06T 2207/10056; G06T 2207/20021; G06T 2207/20081; G06T 2207/20084; G06T 2207/30024

(57) ABSTRACT

Techniques are described herein for architecture-aware image tiling for processing pathology slides. In a particular aspect, a computer-implemented method is provided that includes accessing an image, generating a tiling element for the image based on (i) a number of down-sampling layers to be implemented in a machine learning model, (ii) a size of a kernel to be applied during convolution operations in the machine learning model, (iii) a number of convolutional layers being implemented by the machine learning model at each level or each resolution, or any combination thereof, extracting tiles from the image using the tiling element, inputting each tile into the machine learning model, generating, for each tile, a convolved portion of the image using at least the convolutional layers, the kernel, and the down-sampling layers, generating a convolved version of the image using the convolved portions of the image, and outputting the convolved version of the image.

### CROSS-REFERENCE TO RELATED APPLICATIONS

The present application is a continuation of International Application No. PCT/US2023/028742, filed on Jul. 26, 2023, which claims priority to U.S. Provisional Patent Application No. 63/392,346, filed on Jul. 26, 2022, each of which are hereby incorporated by reference in their entireties for all purposes.

### FIELD

The present disclosure relates to digital pathology, and in particular to techniques for architecture-aware image tiling for processing pathology slides.

### BACKGROUND

Digital pathology involves scanning of slides (e.g., histopathology or cytopathology glass slides) into digital images interpretable on a computer screen. The tissue and/or cells within the digital images may be subsequently examined by digital pathology image analysis and/or interpreted by a pathologist for a variety of reasons including diagnosis of disease, assessment of a response to therapy, and the development of pharmacological agents to fight disease. In order to examine the tissue and/or cells (which are virtually transparent) within the digital images, the pathology slides may be prepared using various stain assays (e.g., immunohistochemistry) that bind selectively to tissue and/or cellular components. Immunofluorescence (IF) is a technique for analyzing assays that bind fluorescent dyes to antigens. Multiple assays responding to various wavelengths may be utilized on the same slides. These multiplexed IF slides enable the understanding of the complexity and heterogencity of the immune context of tumor microenvironments and the potential influence on a tumor's response to immunotherapies. In some assays, the target antigen in the tissue to a stain may be referred to as a biomarker. Thereafter, digital pathology image analysis can be performed on digital images of the stained tissue and/or cells to identify and quantify staining for antigens (e.g., biomarkers indicative of various cells such as tumor cells) in biological tissues.

Artificial intelligence and machine learning based approaches and/or techniques have shown great promise in digital pathology image analysis, such as in cell detection, counting, localization, classification, and patient prognosis. Many computing systems provisioned with machine learning techniques, including convolutional neural networks (CNNs), have been proposed for image classification and digital pathology image analysis, such as cell detection and classification. For example, CNNs can have a series of convolution layers as the hidden layers and this network structure enables the extraction of representational features for object/image classification and digital pathology image analysis. In addition to object/image classification, machine learning techniques have also been implemented for image segmentation. Image segmentation is the process of partitioning a digital image into multiple segments (sets of pixels, also known as image objects). The goal of segmentation is to simplify and/or change the representation of an image into something that is more meaningful and easier to analyze. For example, image segmentation is typically used to locate objects such as cells and boundaries (lines, curves, etc.) in images. To perform image segmentation for large data (e.g., whole slide pathology images), the image is first divided into many small patches. A computing system provisioned with machine learning techniques is trained to classify each pixel in these patches, all pixels in a same class are combined into one segmented area in each patch, and all the segmented patches are then combined into one segmented image (e.g., segmented whole-slide pathology image). Thereafter, machine learning techniques may be further implemented to predict or further classify the segmented area (e.g., positive cells for a given biomarker, negative cells for a given biomarker, or cells that have no stain expression) based on representational features associated with the segmented area.

### SUMMARY

Artificial intelligence and machine learning based approaches have achieved superior performance in digital pathology. However, limitations in computer hardware, most notably memory size in system memory such as the Central Processing Unit (CPU), Graphics Processing Unit (GPU), or Accelerator Card, prevent relatively large images, such as those from digital pathology imaging, from being processed as a whole in their original resolution. A fully convolutional topology, such as a U-Net, is typically trained on down-sampled images and inferred on images of their original size and resolution, by simply dividing the larger image into smaller (typically overlapping) tiles, making predictions on these tiles, and stitching them back together as the prediction for the whole image. Nonetheless, tiling may introduce some challenges, such as artifacts at the tile boundaries or the need for extra processing to blend the results properly. Therefore, choosing the appropriate tiling scheme including tile size and overlap is essential to ensure good performance and avoid artifacts in the final output. Disclosed herein is a framework to implement an architecture-aware tiling scheme that adapts itself to the architecture of the deep neural network that the extracted tiles will be processed by, and additionally demonstrates flexibility to performance-related size constraints.

In various embodiments, a computer-implemented method is provided that comprises: accessing an image; generating a tiling element for the image, wherein the generating the tiling element comprises: determining a number of down-sampling layers to be implemented in a machine learning model that is to be used for processing the image; determining a size of a kernel to be applied during convolution operations in the machine learning model; and generating a non-overlapping core region and an overlapping border region of the tiling element, wherein the overlapping border region surrounds the non-overlapping core region and a size of the non-overlapping core region is determined based on a dimension-reduction attribute N calculated from the number of down-sampling iterations and the size of the kernel; extracting tiles from the image using the tiling element, where each tile has the same non-overlapping core region and the same overlapping border region as the tiling element; inputting each tile into the machine learning model; generating, for each tile, a convolved portion of the image using at least convolutional layers, the kernel, and the down-sampling layers; generating a convolved version of the image using the convolved portions of the image; and outputting the convolved version of the image.

In some embodiments, the machine learning model is configured to include the convolutional layers at each of one or more resolutions; each of the down-sampling iterations leads to a different resolution of an image version being assessed; the generating the tiling element further comprises determining, for each level or each resolution, a number of convolutional layers being implemented by the machine learning model; and the dimension-reduction attribute Nis calculated from the number of down-sampling iterations, the size of the kernel, and number of convolutional layers.

In some embodiments, the convolutional layers without padding or border treatment trim down each tile such that the non-overlapping core region is only used to generate each of the convolved portions of the image.

In some embodiments, extracting the tiles from the image using the tiling element comprises: sliding the tiling element through the image until the tiling element traverses the entire image; and for each portion of the image that the tiling element is aligned as it slides through the image, a corresponding tile is extracted from the portion of the image, where each tile will have the same dimensions as the tiling element including the overlapping border region and the non-overlapping core region.

In some embodiments, as the tiling element slides through the image, the non-overlapping core regions of tiles being extracted from neighboring portions of the image are adjacent to one another but do not overlap with one another and the overlapping border regions of tiles being extracted from neighboring portions of the image do overlap with one another.

In some embodiments, generating, for each tile, the convolved portion of the image, comprises: (i) sliding the kernel over the tile one step at a time; (ii) for each step, a center of the kernel is placed at a specific position on the tile; (iii) during the sliding process, values of the kernel are element-wise multiplied with corresponding values in a input region that the kernel covers on the tile to obtain results; (iv) summing the results of the element-wise multiplication are summed up to obtain a single value, wherein the single value represents output of the kernel at the specific position; and (v) repeating (i)-(iv) for every possible position where the kernel can fit on the tile, where each convolutional layer outputs a new feature map, and where each element of the new feature map represents the output of applying the kernel to the specific position on the tile.

In some embodiments, no padding or border treatment is applied to each tile.

In various embodiments, a computer-implemented method is provided that comprises: identifying a tiling criterion for a machine-learning model, where the tiling criterion is configured such that satisfaction of the tiling criterion requires that a size attribute of an input image exceeds a predefined spatial-metric threshold; accessing an image; determining multiple dimensions of the image; defining a particular size attribute for the image using at least one of the multiple dimensions; determining, based on the particular size attribute for the image, that the tiling criterion is satisfied; in response to determining that the tiling criterion is satisfied: determining a number of down-sampling iterations to be implemented in the machine-learning model; determining a kernel size of a filter to be applied in the machine-learning model; and determining tiling specifications for aligning the filter with various portions across the image based on the number of down-sampling iterations and the kernel size; and generating, for each portion of the various portions of the image as defined by the corresponding tiling specifications, a convolved portion of the image using the filter, the portion, and the machine-learning model; generating a convolved version of the image using the convolved portions of the image; and outputting the convolved version of the image.

In some embodiments, the machine-learning model is configured to include one or more convolutional layers at each of one or more resolutions, where each of the down-sampling iterations leads to a different resolution of an image version being assessed, and where the method further comprising, in response to determining that the tiling criterion is satisfied, determining, for each resolution, a number of convolutional layers being implemented by the machine-learning model, where, for each portion of the various portions of the image as defined by the corresponding specifications, the convolved portion of the image is further generated by using the numbers of convolutional layers being implemented by the machine-learning model.

In some embodiments, determining the tiling specifications for aligning the filter with various portions across the image includes: determining a border distance for the filter that corresponds to a contaminated convolution space where a filter alignment corresponds to an incomplete representation of a corresponding tile of the image.

In some embodiments, determining the specifications for aligning the filter with various portions includes: defining one or more shifts in horizontal movements of the filters based on a width of the filter; and defining one or more shifts in vertical movements of the filters based on a height of the filter.

In some embodiments, generating the convolved version of the image comprises: identifying, for each portion of the various portions of the image as defined by the corresponding tiling specifications, a part of the convolved portion of the image that is predicted to be uncontaminated by edge effects based on the number of down-sampling iterations and the kernel size; and generating the convolved versions using the parts of the convolved portions of the image.

In some embodiments, the image comprises a digital pathology image.

In some embodiments, the machine-learning model is a deep convolutional neural network with at least three convolutional layers.

In some embodiments, the computer-implemented method further comprises determining, by a user, a diagnosis of a subject associated with the image, where the diagnosis is determined based on the inference output by the machine learning model or another machine learning model using the convolved version of the image.

In some embodiments, the computer-implemented method further comprises administering, by the user, a treatment to the subject based on (i) inference output by the machine learning model or another machine learning model using the convolved version of the image, and/or (ii) the diagnosis of the subject.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

Aspects and features of the various embodiments will be more apparent by describing examples with reference to the accompanying drawings, in which:

FIG. 1 illustrates convolution with zero padding in accordance with various embodiments.

FIG. 2 illustrates convolution without padding and treating borders in accordance with various embodiments.

FIG. 3 shows an exemplary network for generating and analyzing digital pathology images in accordance with various embodiments.

FIG. 4 shows a U-Net as an example of deep neural network in accordance with various embodiments.

FIG. 5 illustrates convolution with treated boundaries results in an output image with the same size of input image and contaminated values close to the boundaries in accordance with various embodiments.

FIG. 6 illustrates convolution without boundary treatment results in reduction in the size of the image in accordance with various embodiments.

FIG. 7 shows, top, a tiling element, and bottom, illustration of two neighboring tiles with their overlapping regions in accordance with various embodiments.

FIG. 8 illustrates tiling element sizing considering the network architecture and the performance-related size constraints in accordance with various embodiments.

FIG. 9 shows a flowchart illustrating a process for architecture-aware image tiling in accordance with various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

### 1. Overview

When pathology slides are digitized, they become large images (e.g., gigapixel images), which is mainly because the slides are scanned at high magnifications (e.g., 20× or 40×). Consequently, the entire whole slide image (WSI) typically cannot fit in the system memory (e.g., memory of the CPU, GPU, or Accelerator Card) used to execute a machine learning model, especially when dealing with convolutional neural networks, which can prevent executing downstream image processing algorithms on the whole slide image. To address this reality, an image tiling scheme can be applied in a tiling technique to slice a large image into smaller, overlapping patches or tiles. These tiles are then processed individually by the machine learning model. In these instances, the integrity of an image processing result generated with respect to the WSI depends on how the image processing algorithm is defined in terms of tile sizes, stride, and overlap and what types of successive processes are employed within the algorithm that relate to the tiling technique and/or image tiling scheme (e.g., how to handle boundaries). Thus, choosing the appropriate parameters and processes for the image processing algorithm is essential to ensure good performance, avoid artifacts in the final output, and ultimately improve accuracy of results generated by image processing algorithms that process images using tiling techniques.

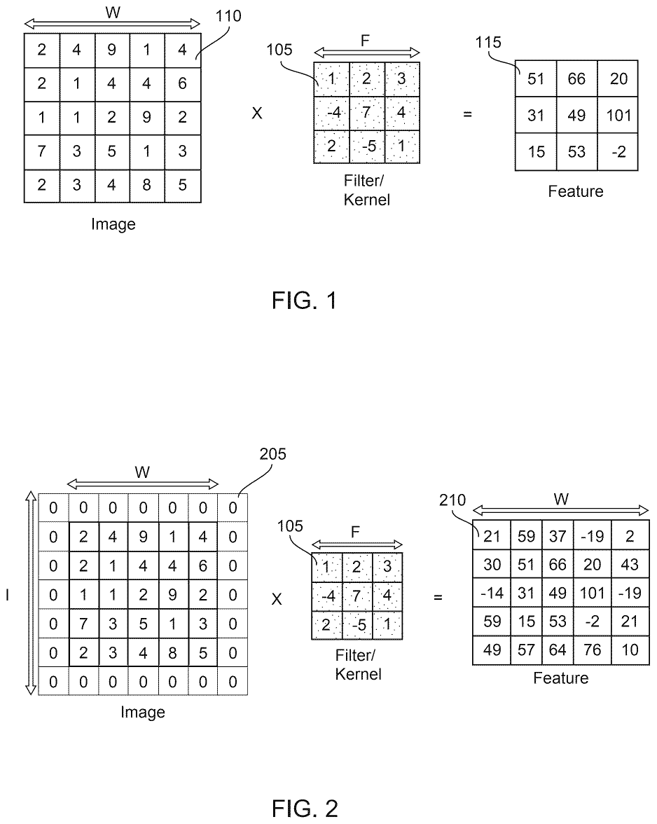

One type of downstream image processing algorithm that can be performed in the context of pathology slides are algorithms that use one or more convolutional neural networks (CNN) in their pipelines. When applying a CNN to process an image, each tile is passed through the CNN just like a regular image and a core operation known as a convolution is applied to each tile. The CNN's convolution operation is applied to each tile by sliding a kernel over the tile to extract features and generating a corresponding feature map for each tile. The kernel is a small matrix of learnable weights which are multiplied with the input to extract relevant features. As the kernel slides over the image and aligns to various portions of a given input image, a convolution value is calculated for each alignment. The convolution value is then assigned to a particular pixel within the portions of the given input image aligned to the kernel (e.g., a pixel aligned to a center of the kernel). FIG. 1 shows an example of a 3×3 kernel 105 that is applied to a 5×5 image 110. The output convolved feature or feature map 115 generated by a convolution operation is 3×3 pixels, because the kernel 105 can fit with a stride of 1 into three different horizontal positions and three different vertical positions within the image 110. Once all the tiles have been processed, their corresponding feature maps are combined to create the final feature map for the entire image. This combination can be achieved by various methods, such as averaging the overlapping regions, taking the maximum value, or using more sophisticated techniques like blending. Notably, this particular approach results in an output feature map or image being smaller than the input image.

In order to control the spatial dimensions of the output feature maps (e.g., to control the size of the output feature maps, to maintain spatial dimensions, and to prevent information loss at the borders of the input image), a padding technique can be used. The padding technique involves adding extra pixels around the edges of the input image such as a tile before applying the convolution, which allows for more space for the kernel to cover in the image. There are generally three types of padding: valid, same, and causal. In valid padding (shown in FIG. 1), no padding is applied. The convolutional filter is restricted to move only over the pixels where it fully overlaps with the input image. If the filter goes beyond the image boundaries, it is simply ignored. As a result, the output feature map will have reduced spatial dimensions compared to the input image.

Same padding is a type of padding commonly used to maintain the spatial dimensions of the input image in the output feature map. For an odd-sized kernel (e.g., 3×3), it adds an equal number of padding pixels (zeros) on all sides of the input image. For an even-sized kernel (e.g., 2×2), it adds one more row and column of padding pixels on the bottom and right edges of the input image. The main purpose of same padding is to ensure that the center pixel of the kernel stays aligned with the center of the input image. FIG. 2 shows a same padding approach where a 1-pixel padding with 0-values is added to the input image 205. This approach generates an output feature map or image 210 that is a same size as the (unpadded) input image 205. However, convolutions of the kernel 215 with portions of the input image 205 that include the padding may then be contaminated due to the padding.

In a standard convolution operation with same or valid padding, the kernel is centered at each position of the input sequence, and the convolution operation is applied to all elements within the kernel's receptive field. This means that when processing a sequence, the output at a certain time step can depend on both past and future elements of the sequence. However, in some cases, it is essential to enforce a causal relationship between the input and output in order to model real-world scenarios accurately. Causal padding addresses this issue by adding padding only to the left side of the input sequence. This ensures that during convolution, the kernel does not have access to future elements of the sequence, thus preserving the causal relationship between the input and output. By preventing the kernel from looking into the future, causal padding allows the CNN to model sequential data in a way that is consistent with the temporal order of the input.

Some CNNs use successive kernel applications. In these instances, the size reduction in the output or the contamination in the output compounds across the kernel applications. Some CNNs use down-sampling techniques, such that intensities (or other attributes) of multiple adjacent pixels are condensed into single values. In these instances, if a single pixel had a value that was contaminated, its impact may “spread” to the multiple adjacent pixels. Further or alternatively, if a kernel application in the down-sampled space occurs, the reduced output size may be magnified in terms of its total impact relative to the original size of the input image. For example, in a U-Net, at each resolution, multiple convolutions are performed. Therefore, if the valid padding technique depicted in FIG. 1 is performed for multiple convolutions, the size of the output image would be dramatically decreased relative to the size of the input image due to convolutions. Meanwhile, if the same padding technique depicted in FIG. 2 is performed, the contamination would dramatically spread from the borders due to the multiple convolutions and down-sampling.

In order to address these challenges and other, a tiling process (e.g., architecture-aware image tiling) was developed and disclosed herein for generating transformed images using strategic tiling schemes. The strategic tiling schemes use architectural specifications of a machine learning model (e.g., size of a kernel, number of convolutional layers, number of down-sampling layers, etc.) to determine how to configure tiles and how to aggregate outputs from machine learning model's outputs to generate an output that reduces or eliminates the impacts of kernel convolutions on predicting image characteristics. More specifically, an amount of contamination or the size reduction for a machine learning model is computed based on a size of a kernel, number of convolutional layers, number of down-sampling layers, or any combination thereof in an architecture of the machine learning model. The disclosed tiling scheme for configuring the tiles has a tiling element (TE) which slides throughout a WSI until it covers the entire WSI. Each TE has an overlapping border region of size N/2 (where N is the amount of contamination or the size reduction) which hugs a non-overlapping core region. While the TE traverses the WSI, the TE is used to extract tiles from portions of the WSI, which can then be input into the machine learning model, the convolutional layers (without border treatment) trim down the tiles to the non-overlapping core region and use the non-overlapping core region to generate feature maps as output for the machine learning model. Consequently, aggregation of machine learning model outputs for each tile provides the result of the machine learning model on the WSI.

In an exemplary embodiment, a computer-implemented method is provided that comprises: accessing an image; generating a tiling element for the image, wherein the generating the tiling element comprises: determining a number of down-sampling layers to be implemented in a machine learning model that is to be used for processing the image; determining a size of a kernel to be applied during convolution operations in the machine learning model; and generating a non-overlapping core region and an overlapping border region of the tiling element, wherein the overlapping border region surrounds the non-overlapping core region and a size of the non-overlapping core region is determined based on a dimension-reduction attribute N calculated from the number of down-sampling iterations and the size of the kernel; extracting tiles from the image using the tiling element, where each tile has the same non-overlapping core region and the same overlapping border region as the tiling element; inputting each tile into the machine learning model; generating, for each tile, a convolved portion of the image using at least convolutional layers, the kernel, and the down-sampling layers; generating a convolved version of the image using the convolved portions of the image; and outputting the convolved version of the image.

In another exemplary embodiment, a computer-implemented method is provided that comprises: identifying a tiling criterion for a machine learning model, wherein the tiling criterion is configured such that satisfaction of the tiling criterion requires that a size attribute of an input image exceeds a predefined spatial-metric threshold; accessing an image; determining multiple dimensions of the image; defining a particular size attribute for the image using at least one of the multiple dimensions; determining, based on the particular size attribute for the image, that the tiling criterion is satisfied; in response to determining that the tiling criterion is satisfied: determining a number of down-sampling iterations to be implemented in the machine learning model; (determining a kernel size of a kernel to be applied in the machine learning model; and determining tiling specifications for aligning the kernel with various portions across the image based on the number of down-sampling iterations and the kernel size; and generating, for each portion of the various portions of the image as defined by the corresponding tiling specifications, a convolved portion of the image using the kernel, the portion, and the machine learning model; generating a convolved version of the image using the convolved portions of the image; and outputting the convolved version of the image.

Advantageously, the architecture-aware image tiling allows a machine learning mode such as a deep neural network to process large images without requiring excessive memory. Since the network operates on smaller tiles, the memory demands are reduced. Moreover, by dividing the image into tiles, it becomes possible to process them in parallel, which can significantly speed up the computation, especially on hardware that supports parallel processing, such as GPUs. The architecture-aware image tiling also enables the machine learning model to handle images of different sizes. The network can process each tile regardless of its size, making it more adaptable to real-world scenarios where images may have varying dimensions. In addition, conventional image processing algorithms compute the convolution operation at boundaries and they will discard the invalid region in the output. In contrast, the disclosed architecture-aware image tiling has the computational advantage (thus a computational resource advantage) that it does not compute the convolution near the boundaries. Since the results of the convolution near the boundaries are always invalid; therefore, the architecture-aware image tiling does not waste computational resources on something that will be discarded in the end. In summary, establishing a proper optimized tiling is crucial for successful analysis of large pathology images especially considering the load of data that is generated by each WSI. The disclosed architecture-aware tiling scheme adapts itself to the architecture of the machine learning model that the extracted tiles will be processed by, additionally; it shows flexibility to the performance-related size constraints.

### II. Definitions

As used herein, when an action is “based on” something, this means the action is based at least in part on at least a part of the something.

As used herein, the terms “substantially,” “approximately,” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

As used herein, the term “sample,” “biological sample,” “tissue,” or “tissue sample” refers to any sample including a biomolecule (such as a protein, a peptide, a nucleic acid, a lipid, a carbohydrate, or a combination thereof) that is obtained from any organism including viruses. Other examples of organisms include mammals (such as humans; veterinary animals like cats, dogs, horses, cattle, and swine; and laboratory animals like mice, rats and primates), insects, annelids, arachnids, marsupials, reptiles, amphibians, bacteria, and fungi. Biological samples include tissue samples (such as tissue sections and needle biopsies of tissue), cell samples (such as cytological smears such as Pap smears or blood smears or samples of cells obtained by microdissection), or cell fractions, fragments or organelles (such as obtained by lysing cells and separating their components by centrifugation or otherwise). Other examples of biological samples include blood, serum, urine, semen, fecal matter, cerebrospinal fluid, interstitial fluid, mucous, tears, sweat, pus, biopsied tissue (for example, obtained by a surgical biopsy or a needle biopsy), nipple aspirates, cerumen, milk, vaginal fluid, saliva, swabs (such as buccal swabs), or any material containing biomolecules that is derived from a first biological sample. In certain embodiments, the term “biological sample” as used herein refers to a sample (such as a homogenized or liquefied sample) prepared from a tumor or a portion thereof obtained from a subject.

As used herein, the term “biological material,” “biological structure,” or “cell structure” refers to natural materials or structures that comprise a whole or a part of a living structure (e.g., a cell nucleus, a cell membrane, cytoplasm, a chromosome, DNA, a cell, a cluster of cells, or the like).

As used herein, a “digital pathology image” refers to a digital image of a stained sample.

As used herein, the term “cell detection” refers to detection of the pixel locations and characteristics of a cell or a cell structure (e.g., a cell nucleus, a cell membrane, cytoplasm, a chromosome, DNA, a cell, a cluster of cells, or the like).

As used herein, the term “target region” refers to a region of an image including image data that is intended be assessed in an image analysis process. Target regions include any region such as tissue regions of an image that is intended to be analyzed in the image analysis process (e.g., tumor cells or staining expressions).

As used herein, the term “tile” or “tile image” refers to a single image corresponding to a portion of a whole image, or a whole slide. In some embodiments, “tile” or “tile image” refers to a region of a whole slide scan or an area of interest having (x,y) pixel dimensions (e.g., 1000 pixels by 1000 pixels). For example, consider a whole image split into M columns of tiles and N rows of tiles, where each tile within the M×N mosaic comprises a portion of the whole image, i.e. a tile at location M1, N1 comprises a first portion of an image, while a tile at location M1, N2 comprises a second portion of the image, the first and second portions being different. In some embodiments, the tiles may each have the same dimensions (pixel size by pixel size). In some instances, tiles can overlap partially, representing overlapping regions of a whole slide scan or an area of interest.

As used herein, the term “patch,” “image patch,” or “mask patch” refers to a container of pixels corresponding to a portion of a whole image, a whole slide, or a whole mask. In some embodiments, “patch,” “image patch,” or “mask patch” refers to a region of an image or a mask, or an area of interest having (x, y) pixel dimensions (e.g., 256 pixels by 256 pixels). For example, an image of 1000 pixels by 1000 pixels divided into 100 pixel×100 pixel patches would comprise 10 patches (each patch containing 1000 pixels). In other embodiments, the patches overlap with each “patch,” “image patch,” or “mask patch” having (x, y) pixel dimensions and sharing one or more pixels with another “patch,” “image patch,” or “mask patch.”

### III. Generation of Digital Pathology Images

Digital pathology involves the interpretation of digitized images in order to correctly diagnose subjects and guide therapeutic decision making. In digital pathology solutions, image-analysis workflows can be established to automatically detect or classify biological objects of interest e.g., positive, negative tumor cells, etc. An exemplary digital pathology solution workflow includes obtaining tissue slides, scanning preselected areas or the entirety of the tissue slides with a digital image scanner (e.g., a whole slide image (WSI) scanner) to obtain digital images, performing image analysis on the digital image using one or more image analysis algorithms, and potentially detecting, quantifying (e.g., counting or identify object-specific or cumulative areas of) each object of interest based on the image analysis (e.g., quantitative or semi-quantitative scoring such as positive, negative, medium, weak, etc.).

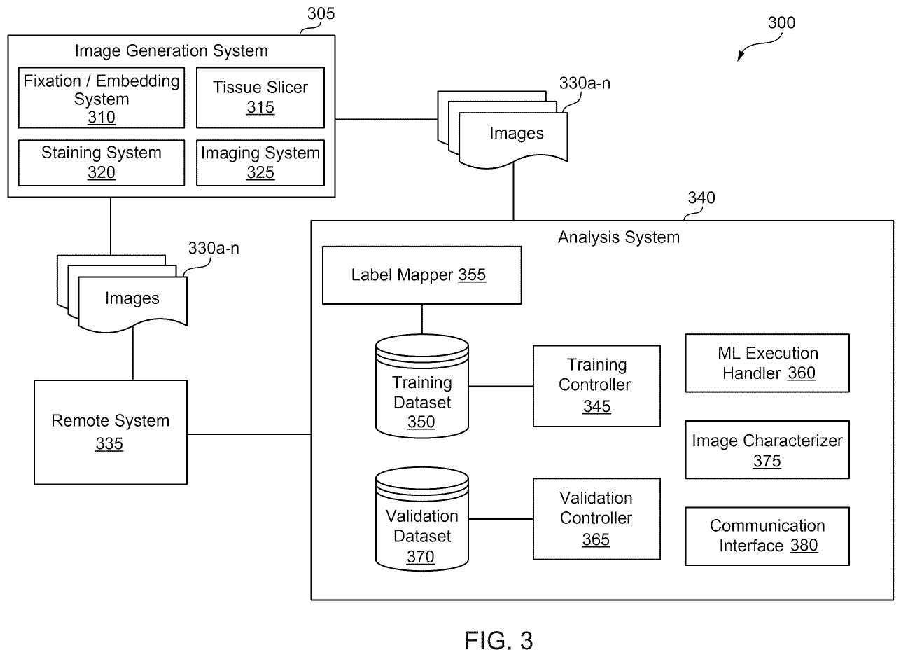

FIG. 3 shows an exemplary network 300 for generating and analyzing digital pathology images. A fixation/embedding system 305 fixes and/or embeds a tissue sample (e.g., a sample including at least part of at least one tumor) using a fixation agent (e.g., a liquid fixing agent, such as a formaldehyde solution) and/or an embedding substance (e.g., a histological wax, such as a paraffin wax and/or one or more resins, such as styrene or polyethylene). Each sample may be fixed by exposing the sample to a fixating agent for a predefined period of time (e.g., at least 3 hours) and by then dehydrating the sample (e.g., via exposure to an ethanol solution and/or a clearing intermediate agent). The embedding substance can infiltrate the sample when it is in liquid state (e.g., when heated).

Sample fixation and/or embedding is used to preserve the sample and slow down sample degradation. In histology, fixation generally refers to an irreversible process of using chemicals to retain the chemical composition, preserve the natural sample structure, and maintain the cell structure from degradation. Fixation may also harden the cells or tissues for sectioning. Fixatives may enhance the preservation of samples and cells using cross-linking proteins. The fixatives may bind to and cross-link some proteins, and denature other proteins through dehydration, which may harden the tissue and inactivate enzymes that might otherwise degrade the sample. The fixatives may also kill bacteria.

The fixatives may be administered, for example, through perfusion and immersion of the prepared sample. Various fixatives may be used, including methanol, a Bouin fixative and/or a formaldehyde fixative, such as neutral buffered formalin (NBF) or paraffin-formalin (paraformaldehyde-PFA). In cases where a sample is a liquid sample (e.g., a blood sample), the sample may be smeared onto a slide and dried prior to fixation. While the fixing process may serve to preserve the structure of the samples and cells for the purpose of histological studies, the fixation may result in concealing of tissue antigens thereby decreasing antigen detection. Thus, the fixation is generally considered as a limiting factor for immunohistochemistry because formalin can cross-link antigens and mask epitopes. In some instances, an additional process is performed to reverse the effects of cross-linking, including treating the fixed sample with citraconic anhydride (a reversible protein cross-linking agent) and heating.

Embedding may include infiltrating a sample (e.g., a fixed tissue sample) with a suitable histological wax, such as paraffin wax. The histological wax may be insoluble in water or alcohol, but may be soluble in a paraffin solvent, such as xylene. Therefore, the water in the tissue may need to be replaced with xylene. To do so, the sample may be dehydrated first by gradually replacing water in the sample with alcohol, which can be achieved by passing the tissue through increasing concentrations of ethyl alcohol (e.g., from 0 to about 100%). After the water is replaced by alcohol, the alcohol may be replaced with xylene, which is miscible with alcohol. Because the histological wax may be soluble in xylene, the melted wax may fill the space that is filled with xylene and was filled with water before. The wax filled sample may be cooled down to form a hardened block that can be clamped into a microtome, vibratome, or compresstome for section cutting. In some cases, deviation from the above example procedure may result in an infiltration of paraffin wax that leads to inhibition of the penetration of antibody, chemical, or other fixatives.

A tissue slicer 310 may then be used for sectioning the fixed and/or embedded tissue sample (e.g., a sample of a tumor). Sectioning is the process of cutting thin slices (e.g., a thickness of, for example, 4-5 μm) of a sample from a tissue block for the purpose of mounting it on a microscope slide for examination. Sectioning may be performed using a microtome, vibratome, or compresstome. In some cases, tissue can be frozen rapidly in dry ice or Isopentane, and can then be cut in a refrigerated cabinet (e.g., a cryostat) with a cold knife. Other types of cooling agents can be used to freeze the tissues, such as liquid nitrogen. The sections for use with brightfield and fluorescence microscopy are generally on the order of 4-10 μm thick. In some cases, sections can be embedded in an epoxy or acrylic resin, which may enable thinner sections (e.g., <2 μm) to be cut. The sections may then be mounted on one or more glass slides. A coverslip may be placed on top to protect the sample section.

Because the tissue sections and the cells within them are virtually transparent, preparation of the slides typically further includes staining (e.g., automatically staining) the tissue sections in order to render relevant structures more visible. In some instances, the staining is performed manually. In some instances, the staining is performed semi-automatically or automatically using a staining system 320. The staining process includes exposing sections of tissue samples or of fixed liquid samples to one or more different stains (e.g., consecutively or concurrently) to express different characteristics of the tissue.

For example, staining may be used to mark particular types of cells and/or to flag particular types of nucleic acids and/or proteins to aid in the microscopic examination. The staining process generally involves adding a dye or stain to a sample to qualify or quantify the presence of a specific compound, a structure, a molecule, or a feature (e.g., a subcellular feature). For example, stains can help to identify or highlight specific biomarkers from a tissue section. In other example, stains can be used to identify or highlight biological tissues (e.g., muscle fibers or connective tissue), cell populations (e.g., different blood cells), or organelles within individual cells.

One exemplary type of tissue staining is histochemical staining, which uses one or more chemical dyes (e.g., acidic dyes, basic dyes, chromogens) to stain tissue structures. Histochemical staining may be used to indicate general aspects of tissue morphology and/or cell microanatomy (e.g., to distinguish cell nuclei from cytoplasm, to indicate lipid droplets, etc.). One example of a histochemical stain is H&E. Other examples of histochemical stains include trichrome stains (e.g., Masson's Trichrome), Periodic Acid-Schiff (PAS), silver stains, and iron stains. The molecular weight of a histochemical staining reagent (e.g., dye) is typically about 500 kilodaltons (kD) or less, although some histochemical staining reagents (e.g., Alcian Blue, phosphomolybdic acid (PMA)) may have molecular weights of up to two or three thousand kD. One case of a high-molecular-weight histochemical staining reagent is alpha-amylase (about 55 kD), which may be used to indicate glycogen.

Another type of tissue staining is IHC, also called “immunostaining”, which uses a primary antibody that binds specifically to the target antigen of interest (also called a biomarker). IHC may be direct or indirect. In direct IHC, the primary antibody is directly conjugated to a label (e.g., a chromophore or fluorophore). In indirect IHC, the primary antibody is first bound to the target antigen, and then a secondary antibody that is conjugated with a label (e.g., a chromophore or fluorophore) is bound to the primary antibody. The molecular weights of IHC reagents are much higher than those of histochemical staining reagents, as the antibodies have molecular weights of about 150 kD or more.

Various types of staining protocols may be used to perform the staining. For example, an exemplary IHC staining protocol includes using a hydrophobic barrier line around the sample (e.g., tissue section) to prevent leakage of reagents from the slide during incubation, treating the tissue section with reagents to block endogenous sources of nonspecific staining (e.g., enzymes, free aldehyde groups, immunoglobins, other irrelevant molecules that can mimic specific staining), incubating the sample with a permeabilization buffer to facilitate penetration of antibodies and other staining reagents into the tissue, incubating the tissue section with a primary antibody for a period of time (e.g., 1-24 hours) at a particular temperature (e.g., room temperature, 6-8° C.), rinsing the sample using wash buffer, incubating the sample (tissue section) with a secondary antibody for another period of time at another particular temperature (e.g., room temperature), rinsing the sample again using water buffer, incubating the rinsed sample with a chromogen (e.g., DAB: 3,3′-diaminobenzidine), and washing away the chromogen to stop the reaction. In some instances, counterstaining is subsequently used to identify an entire “landscape” of the sample and serve as a reference for the main color used for the detection of tissue targets. Examples of the counterstains may include hematoxylin (stains from blue to violet), Methylene blue (stains blue), toluidine blue (stains nuclei deep blue and polysaccharides pink to red), nuclear fast red (also called Kernechtrot dye, stains red), and methyl green (stains green); non-nuclear chromogenic stains, such as eosin (stains pink), etc. A person of ordinary skill in the art will recognize that other immunohistochemistry staining techniques can be implemented to perform staining.

In another example, an H&E staining protocol can be performed for the tissue section staining. The H&E staining protocol includes applying hematoxylin stain mixed with a metallic salt, or mordant to the sample. The sample can then be rinsed in a weak acid solution to remove excess staining (differentiation), followed by bluing in mildly alkaline water. After the application of hematoxylin, the sample can be counterstained with eosin. It will be appreciated that other H&E staining techniques can be implemented.

In some embodiments, various types of stains can be used to perform staining, depending on which features of interest is targeted. For example, DAB can be used for various tissue sections for the IHC staining, in which the DAB results a brown color depicting a feature of interest in the stained image. In another example, alkaline phosphatase (AP) can be used for skin tissue sections for the IHC staining, since DAB color may be masked by melanin pigments. With respect to primary staining techniques, the applicable stains may include, for example, basophilic and acidophilic stains, hematin and hematoxylin, silver nitrate, trichrome stains, and the like. Acidic dyes may react with cationic or basic components in tissues or cells, such as proteins and other components in the cytoplasm. Basic dyes may react with anionic or acidic components in tissues or cells, such as nucleic acids. As noted above, one example of a staining system is H&E. Eosin may be a negatively charged pink acidic dye, and hematoxylin may be a purple or blue basic dye that includes hematein and aluminum ions. Other examples of stains may include periodic acid-Schiff reaction (PAS) stains, Masson's trichrome, Alcian blue, van Gieson, Reticulin stain, and the like. In some embodiments, different types of stains may be used in combination.

The sections may then be mounted on corresponding slides, which an imaging system 325 can then scan or image to generate raw digital-pathology images 330a-n. A microscope (e.g., an electron or optical microscope) can be used to magnify the stained sample. For example, optical microscopes may have a resolution less than 1 μm, such as about a few hundred nanometers. To observe finer details in nanometer or sub-nanometer ranges, electron microscopes may be used. An imaging device (combined with the microscope or separate from the microscope) images the magnified biological sample to obtain the image data, such as a multi-channel image (e.g., a multi-channel fluorescent) with several (such as between ten to sixteen, for example) channels. The imaging device may include, without limitation, a camera (e.g., an analog camera, a digital camera, etc.), optics (e.g., one or more lenses, sensor focus lens groups, microscope objectives, etc.), imaging sensors (e.g., a charge-coupled device (CCD), a complimentary metal-oxide semiconductor (CMOS) image sensor, or the like), photographic film, or the like. In digital embodiments, the imaging device can include a plurality of lenses that cooperate to prove on-the-fly focusing. An image sensor, for example, a CCD sensor can capture a digital image of the biological sample. In some embodiments, the imaging device is a brightfield imaging system, a multispectral imaging (MSI) system or a fluorescent microscopy system. The imaging device may utilize nonvisible electromagnetic radiation (UV light, for example) or other imaging techniques to capture the image. For example, the imaging device may comprise a microscope and a camera arranged to capture images magnified by the microscope. The image data received by the analysis system may be identical to and/or derived from raw image data captured by the imaging device.

The images of the stained sections may then be stored in a storage device or remote system 335 such as a server. The images may be stored locally, remotely, and/or in a cloud server. Each image may be stored in association with an identifier of a subject and a date (e.g., a date when a sample was collected and/or a date when the image was captured). An image may further be transmitted to another system (e.g., a system associated with a pathologist, an automated or semi-automated image analysis system, a machine learning training and deployment system, or any combination thereof, as described in further detail herein).

In some instances, the network 300 can include an image analysis system 340 to train and execute a machine learning model. Examples of a machine learning model can be a deep convolutional neural network, a U-Net, a V-Net, a residual neural network, or a recurrent neural network. The machine learning model may be trained and/or used to (for example) predict whether a biomedical image includes a depiction of a set of tumor cells or other structural and/or functional biological entities associated with a disease, whether the biomedical image is associated with a diagnosis of the disease, whether the biomedical image is associated with a classification (e.g., stage, subtype, etc.) of the disease, and/or the biomedical image is associated with a prognosis for the disease. The prediction may characterize a presence of, quantity of and/or size of the set of tumor cells or the other structural and/or functional biological entities, the diagnosis of the disease, the classification of the disease, and/or the prognosis of the disease.

A training controller 345 can execute code to train the machine learning model and/or the other machine learning model(s) using one or more training datasets 350. Each training dataset 350 can include a set of training biomedical images from images 330a-n (e.g., retrieved from remote system 335). Each of the biomedical images may include a digital pathology image, CT image, MRI image, ultrasound image, etc. that depicts one or more biological objects (e.g., a set of cells of one or more types). Each of the biomedical images may depict a portion of a sample, such as a tissue sample (e.g., colorectal, bladder, breast, pancreas, lung, or gastric tissue), a blood sample or a urine sample. In some instances, each of one or more of the biomedical images depicts a plurality of tumor cells or a plurality of other structural and/or functional biological entities. The training dataset 350 may have been collected (for example) from the imaging system 325.

The training controller 345 can identify an indication of a representative distribution of characteristics of a disease. The analysis system 340 may access and analyze one or more databases of clinical data associated with the disease to determine the representative distribution of the characteristics and communicate the indication of the representative distribution to the training controller 345. Alternatively, the training controller 345 may receive the indication via a user input from a remote system 335, which may be associated with (for example) a physician, nurse, hospital, pharmacist, etc. associated. The representative distribution can correspond to realistic percentages of the various characteristics with respect to each other. For instance, a particular variant of a disease may be present in a certain percentage of subjects who have the disease. So, the representative distribution can indicate the certain percentage for the particular variant. Other characteristics can include a relapse rate of the disease, international prognostic index risk factors, and/or demographic factors of the disease. In addition to clinical characteristics, the representative distribution can also include technical characteristics, which can specify equipment and process-related characteristics. For example, technical characteristics may involve types of staining protocols (e.g., types of stains, and/or numbers of stains) used by the staining system 320, types of scanners of the imaging system 325, one or more types of data acquisition methods of the imaging system 325, etc. The technical characteristics may be determined based on the disease, since different diseases may be visualized better using a particular scanner or staining protocol.

The training controller 345 can generate the training dataset 350 to have a distribution of characteristics that corresponds to the representative distribution of the characteristics of the disease. The distribution may correspond to the representative distribution in a manner such that one or more measured properties of the distribution of the training dataset 345 are sufficiently close to (e.g., within a predefined absolute value from, within a predefined percentage from, etc.) the representative distribution, an integral (or normalized integral) of an overlap of the distribution and the representative distribution exceeds a threshold, etc. Generating the training dataset 350 can involve the training controller 345 defining or selecting a set of the images 330 that have the representative distribution. For example, breast cancer carcinoma may have a representative distribution of a ductal subtype occurring in 80-85% of cases and a lobular and other rare subtypes occurring in 15-20% of cases. So, the images included in the training dataset 350 can have a distribution of characteristics equal to or sufficiently close to (e.g., within 1%) the distribution of characteristics indicated in the representative distribution.

In some instances, the training controller 345 may determine that the images 330 lack representative data for one or more characteristics of the disease. For instance, if the disease is breast cancer, and the representative distribution can indicate that 1% of breast cancer cases involve a biopsy that stains positive for a lobular subtype. But, the training controller 345 may determine that the images 330 lack a combination of characteristics of a biopsy that stains positive for the lobular subtype that can make up 1% of the training dataset 350. Upon making this determination, the training controller 345 may output a notification to the remote system 335 indicating that the images 330 do not include representative data for the particular combination of characteristics. The training controller 345 can then receive, from the remote system 335, an adjustment for a value of the characteristic(s). For example, the adjustment may indicate that 0.5%, rather than 1%, of the training dataset 350 is to include a biopsy that stains positive for the lobular subtype. Based on the adjustment, the training controller 345 can generate the training dataset 350.

The analysis system 340 can include a label mapper 355 that maps the images 330 from the imaging system 325 containing tumor cells or other structural and/or functional biological entities associated with the disease to a “tumor” label and that maps images 330 not containing tumor cells or other structural and/or functional biological entities associated with the disease to a “non-tumor” label. Mapping data may be stored in a mapping data store (not shown). The mapping data may identify each image that is mapped to either of the tumor label or non-tumor label.

In some instances, labels associated with the training dataset 350 may have been received or may be derived from data received from the remote system 350. The received data may include (for example) one or more medical records corresponding to a particular subject to which one or more of the images 330 corresponds. The medical records may indicate (for example) a professional's diagnosis or characterization that indicates, with respect to a time period corresponding to a time at which one or more input image elements associated with the subject were collected or a subsequent defined time period, whether the subject had a tumor and/or a stage of progression of the subject's tumor (e.g., along a standard scale and/or by identifying a metric, such total metabolic tumor volume (TMTV)). The received data may further include the pixels of the locations of tumors or tumor cells within the one or more images associated with the subject. Thus, the medical records may include or may be used to identify, with respect to each training image, one or more labels. In some instances, images or scans that are input to one or more classifier subsystems are received from the remote system 335. For example, the remote system 335 may receive images 330 from the image generation system 305 and may then transmit the images 330 or scans (e.g., along with a subject identifier and one or more labels) to the analysis system 340.

Training controller 345 can use the mappings of the training dataset 350 to train a machine learning model. More specifically, training controller 345 can access an architecture of a model, define (fixed) hyperparameters for the model (which are parameters that influence the learning process, such as e.g. the learning rate, size/complexity of the model, etc.), and train the model such that a set of parameters are learned. More specifically, the set of parameters may be learned by identifying parameter values that are associated with a low or lowest loss, cost, or error generated by comparing predicted outputs (obtained using given parameter values) with actual outputs. In some instances, a machine learning model can be configured to iteratively fit new models to improve estimation accuracy of an output (e.g., that includes a metric or identifier corresponding to an estimate or likelihood as to portions of the image that include depictions of tumor cells or other structural and/or functional biological entities). Using a training dataset with the distribution corresponding to the representative distribution to train the machine learning model may result in a trained machine learning model that can more accurately detect depictions of tumor cells or other structural and/or functional biological entities associated with the disease than a machine learning model trained with a training dataset that is different than the representative distribution.

A machine learning (ML) execution handler 360 can use the architecture of a machine learning model and learned parameters to process non-training data and generate a result. For example, ML execution handler 360 may access biomedical image not represented in the training dataset 350. For example, the biomedical image may be a histopathological image of a slice of specimen not represented in the training dataset 350. In some embodiments, the biomedical image generated is stored in a memory device. The image may be generated using the imaging system 325. In some embodiments, the image is generated or obtained from a microscope or other instrument capable of capturing image data of a specimen-bearing microscope slide, as described herein. In some embodiments, the biomedical image is generated or obtained using a 2D scanner, such as one capable of scanning image tiles. Alternatively, the image may have been previously generated (e.g., scanned) and stored in a memory device (or, for that matter, retrieved from a server via a communication network).

In some instances, the biomedical image may be fed, by the ML execution handler 360, into a trained machine learning model having an architecture (e.g., U-Net) used during training and configured with learned parameters. In other instances, the biomedical image may first be broken down, by the ML execution handler 360, into smaller parts (e.g., tiles), as described in further detail herein, and then each tile is fed, by the ML execution handler 360, into a trained machine learning model having an architecture (e.g., U-Net) used during training and configured with learned parameters. The trained machine learning model may or may not have been trained with the training dataset 350 having a distribution of characteristics corresponding to the representative distribution. The trained machine learning model can output a feature map or image, a classification, or a prediction such as a prediction of whether or not the image depicts tumor cells or other structural and/or functional biological entities associated with the disease.

A validation controller 365 can feed one or more biomedical images into the trained machine learning model to evaluate performance metrics for the predictions output by the trained machine learning model. For instance, one or more validation datasets 370 of biomedical images may be generated to test an accuracy, precision, sensitivity, and/or F-score of the trained machine learning model in predicting the depictions of tumor cells for the disease. Each validation dataset 370 can include a set of validation biomedical images from images 330a-n. In some instances, each of one or more of the biomedical images depicts a plurality of tumor cells or a plurality of other structural and/or functional biological entities. The validation dataset 370 may have been collected (for example) from the image generation system 305.

The validation controller 365 can generate the validation dataset 370 to have a distribution of characteristics corresponding to the representative distribution of the characteristics of the disease. The distribution can correspond to the representative distribution such that one or more measured properties of the distribution of the validation dataset 370 are sufficiently close to the representative distribution. Since the representative distribution may change over time, the validation dataset 370 can be evaluated and modified, as necessary. In some instances, the validation controller 365 may perform a gap analysis between the representative distribution and the validation dataset 370 to evaluate the validation dataset 370. For example, upon generating the validation dataset 370, the validation controller 365 may determine the distribution of the characteristics of the disease in the validation dataset 370. The validation controller 365 can then compare the representative distribution to the determined distribution for the validation dataset 370 and determine whether there are any differences between the representative distribution and the determined distribution. If there is a difference, the validation controller 365 can modify the validation dataset 370 to mitigate the difference. For example, if the representative distribution involves 50% of diffuse large B-cell lymphoma cases being a germinal center B-cell subtype and 50% being an activated B-cell subtype and the validation controller 365 determines that 45% of the images in the validation dataset 370 are for the germinal center B-cell subtype and 55% are for the activated B-cell subtype, the validation controller 365 can modify the validation dataset 370 to include 50% images for the germinal center B-cell subtype and 50% images for the activated B-cell subtype.

Similar to the training dataset 350, if the validation controller 365 determines that the images 330a-n do not include representative data for a characteristic, the validation controller 365 may output a notification to the remote system 335 and receive an adjustment for an amount of the characteristic in the validation dataset 370. The validation controller 365 can then generate the validation dataset 370 accordingly.

In some instances, the ML execution handler 360 can access the validation dataset 370 and process the validation dataset 370 using the trained machine learning model. For each image in the validation dataset 370, the ML execution handler 360 can generate a prediction of a depiction of tumor cells or other structural and/or functional biological entities of the disease in the image. The validation controller 365 can compare the predictions to ground truths of the images depicting tumor cells or other structural and/or functional biological entities (e.g., based on the labels generated by the label mapper 355). Based on the comparison, the validation controller 365 can determine performance metrics for the trained-machine learning model. The performance metrics can include an accuracy, precision, sensitivity, and/or F-score of the trained machine learning model in predicting the depictions of tumor cells or other structural and/or functional biological entities for the disease.

The validation controller 365 may identify a threshold criterion for a metric associated with the prediction. For example, the threshold criterion may be a lower limit of 0.8 for the accuracy of predicting a depiction of tumor cells or other structural and/or functional biological entities. If the validation controller 365 determines that the trained machine learning model satisfies the threshold criterion by exceeding 0.8 for the accuracy, the validation controller 365 can avail the trained machine learning model for subsequent processing of biomedical images. For instance, the validation controller 365 may make the trained machine learning model available to other entities or systems for processing biomedical images associated with the disease. Once availed, the trained machine learning model can receive biomedical images and output predictions of the biomedical images depicting tumors cells or other structural and/or functional biological entities.

Alternatively, if the validation controller 365 determines that the metric does not satisfy the threshold criterion, the validation controller 365 may still avail the trained machine learning model for subsequent processing of biomedical images, but the subsequent processing of biomedical images may result in the prediction and a confidence level of the prediction being output by the trained machine learning model. The confidence level may be quantitative (e.g., a percentage or decimal) or qualitative (e.g., an indication of low, medium, or high). Outputting the confidence level can allow a user to decide whether the prediction is to be trusted or whether additional processing is to be performed for a biomedical image before a determination of the presence of tumor cells or other structural and/or functional biological entities can be made.

In some instances, once the trained machine learning model is availed for subsequent processing of biomedical images and the subsequent processing of a biomedical image has occurred by the ML execution handler 360, an image characterizer 375 identifies a predicted characterization for the biomedical image based on the execution of the image processing. The execution may itself produce a result that includes the characterization, or the execution may include results that image characterizer 375 can use to determine a predicted characterization of the specimen. For example, the subsequent processing may include characterizing a presence, quantity of, and/or size of a set of tumor cells or other structural and/or functional biological entities predicted to be present in the biomedical image. The subsequent processing may additionally or alternatively include characterizing other structural and/or functional biological entities predicted to be present in the biomedical image, the diagnosis of the disease predicted to be present in the biomedical image, the classification of the disease predicted to be present in the biomedical image, and/or the prognosis of the disease predicted to be present in the biomedical image. Image characterizer 375 may apply rules and/or transformations to map the probability and/or confidence to a characterization. As an illustration, a first characterization may be assigned if a result includes a probability greater than 50% that the biomedical image includes a set of tumor cells, and a second characterization may be otherwise assigned.

A communication interface 380 can collect results and communicate the result(s) (or a processed version thereof) to a user device (e.g., associated with a laboratory technician or care provider) or other system. For example, the results may be communicated to the remote system 335. In some instances, the communication interface 380 may generate an output that identifies the presence of, quantity of and/or size of the set of tumor cells or other structural and/or functional biological entities, the diagnosis of the disease, the classification of the disease, and/or the prognosis of the disease. The output may then be presented, rendered, and/or transmitted, which may facilitate a display of the output data, for example on a display of a computing device. The result may be used to determine a diagnosis, a treatment plan, or to assess an ongoing treatment for the tumor cells.

It will be appreciated that modifications to processes described with respect to network 300 are contemplated. For example, if a sample is a liquid sample, embedding and/or sectioning may be omitted from the process.

### IV. Architecture-Aware Image Tiling for Analyzing Pathology Slides or Scans

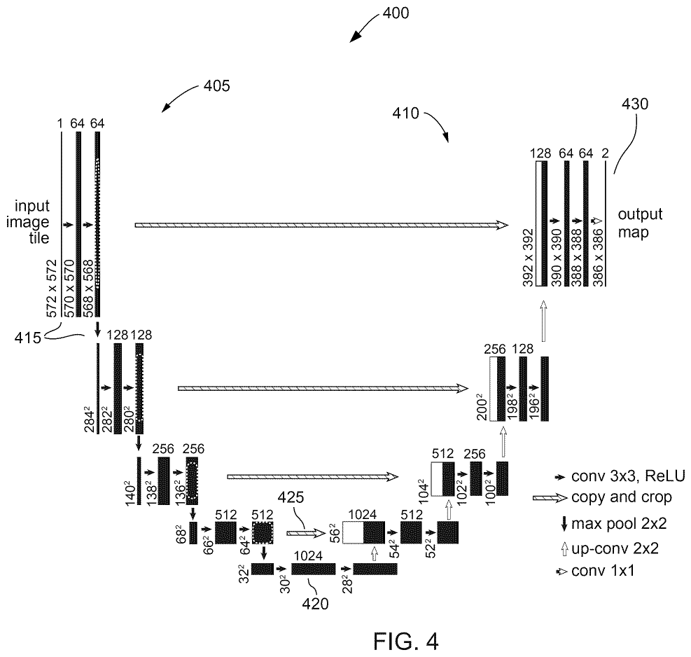

A U-Net is a common deep neural network architecture used in computer vision and for digital pathology image analysis. The following discussion regarding the architecture-aware image tiling will pertain to application of this tiling technique for a U-Net architecture; however, it should be understood that the same discussion and computations can be applied to other CNNs including without limitation a V-Net, a residual neural network, or a recurrent neural network. As shown in FIG. 4, a U-Net 400 includes a contracting path 405 and an expansive path 410, which gives it a u-shaped architecture. The contracting path 405 is a CNN network that includes repeated application of convolutions (e.g., 3×3 convolutions), each followed by a rectified linear unit (ReLU) and a max pooling operation (e.g., a 2×2 max pooling) for down sampling. The input for a convolutional operation is a two-dimensional tile or three-dimensional volume (e.g., the input images of size n×n, where n is a number of input features or pixels) and a set of ‘k’ kernals (also called feature extractors) each one of size (e.g., f×f, where f is any number, for example, 3 or 5). The output of a convolutional operation is also a two-dimensional tile or three-dimensional volume (also called as output image or feature map) of size (m×m×k, where m is a number of output features and k is the convolutional kernel size).

Each block 415 of a contraction path 315 includes one or more convolutional layers (denoted by gray horizontal arrows), and the number of feature channels changes, e.g., from 1→64, as convolution processes will increase the depth of the input image. The gray arrow pointing down between each block 415 is the max pooling process which halves down the size of the input image. At each downsampling step or pooling operation, the number of feature channels may be doubled. During the contraction, the spatial information of the image data is reduced while feature information is increased. Thus, before pooling, the information which was present in, e.g., a 572×572 image, after pooling, (almost) the same information is now present in, e.g., a 284×284 image. Now when the convolution operation is applied again in a subsequent process or layer, the filters in the subsequent process or layer will be able to see larger context, i.e., as the input image progresses deeper into the network, the size of the input image reduces however the receptive field increases (receptive field (context) is the area of the input image that the kernel covers at any given point of time). Once the blocks 415 are performed, two more convolutions may be performed in block 420 but with no max pooling. The image after block 420 has been resized to e.g., 28×28×1024 (this size is merely illustrative and the size at the end of process 420 could be different depending on the starting size of the input image-size n×n×channels).

After the image has been resized, e.g., to 28×28×1024, the image is concatenated with the corresponding image from the contracting path (see the horizontal gray bar 425 from the contracting path 405) and together makes an image of size 56×56×1024. The reason for the concatenation is to combine the information from the previous layers (i.e., the high-resolution features from the contracting path 405 are combined with the upsampled output from the expansive path 410) in order to get a more precise prediction. This process continues as a sequence of up-convolutions (upsampling operators) that halves the number of channels, concatenations with a correspondingly cropped feature map from the contracting path 405, repeated application of convolutions (e.g., two 3×3 convolutions) that are each followed by a rectified linear unit (ReLU), and a final convolution in block 430 (e.g., one 1×1 convolution) to generate a feature map or output image.

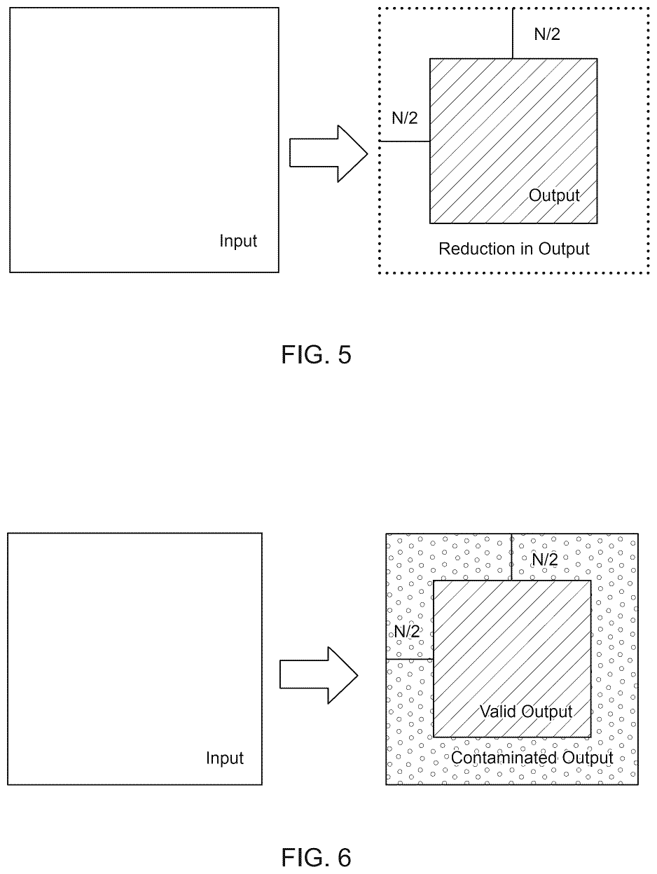

As described herein, if the convolutional layers in the contracting path 405 and the expansive path 410 perform the convolution operation with boundary treatment, the size of the output will be the same as the input. However, areas close to the image boundaries contain “contaminated” values and this is because the boundaries of the image are padded with values that are not legitimate image values (see FIG. 5). If the convolutional layers in the contracting path 405 and the expansive path 410 perform the convolution operation without boundary treatment, there will be a reduction in image size (see FIG. 6). As illustrated in FIGS. 5 and 6, a dimension-reduction attribute N corresponds to the extent to which an output from a machine learning model with an architecture such as the U-Net 400 is reduced in size or contaminated by applying a kernel to an input image with padding or with no padding, respectively.

One approach for calculating the dimension-reduction attribute N when a machine learning model being used has a standard U-Net architecture is to define the attribute in accordance with the following equations (1-3):

$${N}_{e} = {\sum }_{i = 0}^{D} {2}^{i} C ( F - 1 ) = C ( F - 1 ) ( {2}^{D + 1} - 1 ) , \qquad ( Equation ( 1 )$$

$${N}_{d} = C ( F - 1 ) ( {2}^{D} - 1 ) , \qquad Equation ( 2 )$$

$$N = {N}_{e} + {N}_{d} . \qquad Equation ( 3 )$$

where F is the size of the kernel, C is the number of convolutional layers at each level, and D is the number of pooling layers in the U-Net architecture. However, it should be understood that equations for calculating the dimension-reduction attribute N may be adapted to account for various architectural features including but not limited to kernel size, convolutional layers, pooling layers, up-convolutions, concatenations, rectified linear units, and the like in other architectures.

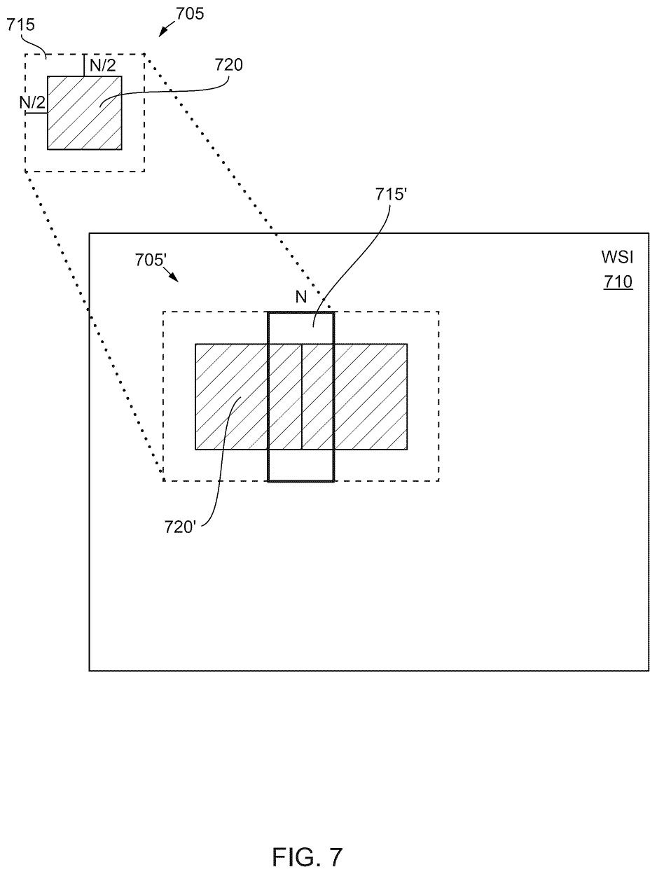

As shown in FIG. 7, the architecture-aware image tiling includes implementing a tiling scheme that slides a tiling element (TE) 705 through a whole-slide image (WSI) 710 until it traverses the entire WSI 710. The TE 705 includes an overlapping border region 715 of size N/2 (based on dimension-reduction attribute N as computed in Equations 1-3) which hugs a non-overlapping core region 720 (the shaded area in FIG. 7). For each portion of the WSI 710 that the TE 705 is aligned as it slides through the WSI 710, a corresponding tile 705′ is extracted from the portion of the WSI 710. Each tile will have the same dimensions as the TE 705 including the overlapping border region 715′ of size N/2 and the non-overlapping core region 720′. As illustrated in FIG. 7, as the TE 705 slides through the WSI 710, the core regions 720 corresponding to core regions 720′ of tiles 705′ being extracted from neighboring portions of the WSI 710 touch (are adjacent to one another) but do not overlap with one another (hence non-overlapping regions). In contrast, the border region 715 corresponding to border region 715′ of tiles 705′ being extracted from neighboring portions of the WSI 710 do not just touch one another but instead overlap with one another (hence overlapping regions). This approach facilitates ensuring that adjacent outputs do not overlap with respect to convolutions for which kernels were fully aligned with non-padding values and that there are no gaps corresponding to pixels for which a kernel was fully aligned with non-padding values.

Each tile 705′, extracted as the TE 705 slides through the WSI 710, is input to the machine learning model and the convolutional layers (without padding or border treatment) trim down the tile 705′ such that the core region 720′ is only used to generate the feature map or image outputs of the machine learning model. Consequently, an aggregation of the feature map or image outputs of the machine learning model provides the overall result of the machine learning model on the WSI 710.

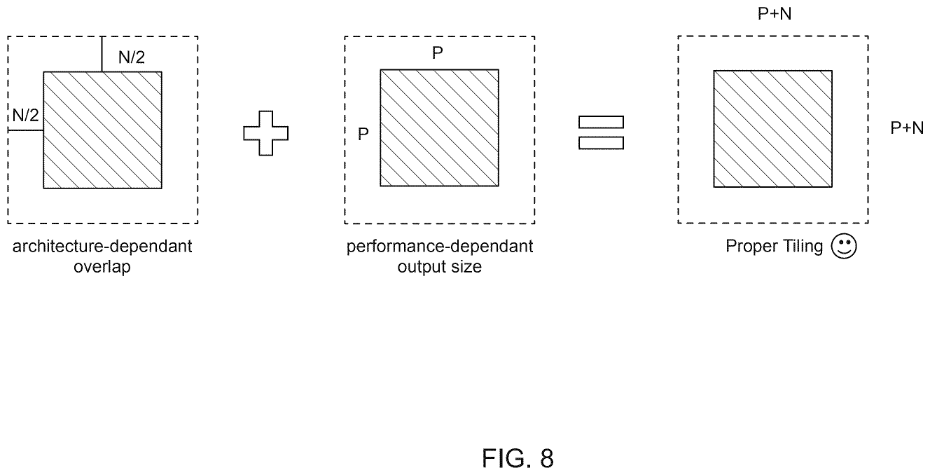

However, because each WSI 710 can easily yield a few thousand tiles 705′ (depending on the size of tissue and the size of the TE 705), there may be a need to further optimize the downstream image processing to achieve—in addition to producing more accurate results-efficient data transfer between CPU and GPU, storing results, retrieval of data, and the like. In order to further optimize and achieve the most time efficient image processing pipeline, specific size constraints can be introduced to the overlapping border region 715 beyond those introduced based on architecture, i.e., the dimension-reduction attribute N. The size constraints can be determined based on performance efficiency P of the machine learning model and system it is running upon. The performance efficiency P can be calculated in a similar manner as described herein with respect to the dimension-reduction attribute N; but equations can be adapted to account for various performance features including but not limited to data transfer rates between CPU and GPU, available storage or memory, data transfer rates for retrieval of data from various subsystems, processing speeds, and the like. As illustrated in FIG. 8, the architecture-aware image tiling can facilitate an efficient and accurate pipeline for processing images that can accommodate any size constraints on the overlapping border region 715 related to the performance efficiency of the machine learning model and system it is running upon, while still be faithful to the deep network architecture.

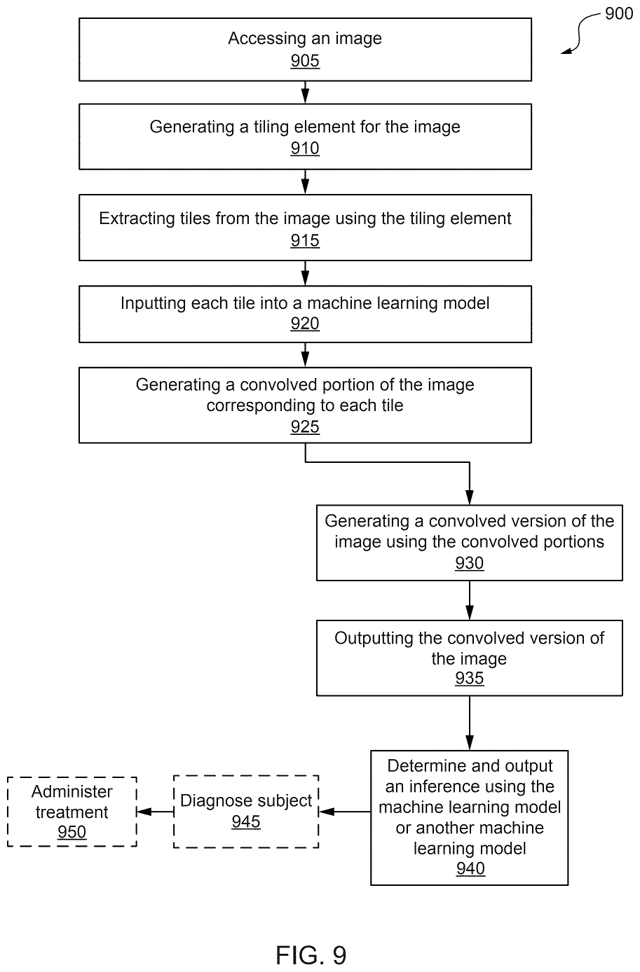

FIG. 9 shows a flowchart illustrating a process 900 for image processing using architecture-aware image tiling in accordance with various embodiments. The process 900 depicted in FIG. 9 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 900 presented in FIG. 9 and described below is intended to be illustrative and non-limiting. Although FIG. 9 depicts the various processing steps occurring in a particular sequence or order, this is not intended to be limiting. In certain alternative embodiments, the steps may be performed in some different order or some steps may also be performed in parallel. In certain embodiments, such as in the embodiments depicted in FIGS. 3-8, the processing depicted in FIG. 9 may be performed by or as part of a network comprising an image generation system and analysis system (e.g., image generation system 305 and analysis system 340 described with respect to FIG. 3) to generate images and process those images using a machine learning model with a deep network architecture.

Process 900 starts at block 905, at which an image is accessed. The image may be a digital pathology image such as a whole slide image comprising one or more types of cells. The image may have been generated in multiple dimensions by an imaging system and thus part of access the image may include identifying or determining the multiple dimensions of the image. A particular size attribute for the image may also be identified or determined based on the multiple dimensions of the image. For example, a two dimensional whole slide image may have a size attribute of 100,000×100,000 pixels. In some instances, prior to accessing the image, a tiling criterion is identified for a machine learning model to be used to process the image. The tiling criterion is configured such that the machine learning model and system it is running upon including the memory resources would be able to handle processing of the image at the given size attribute. If the size attribute of the image exceeds a predefined spatial-metric threshold, then the tiling criterion is satisfied, and the image will need to be tiled prior to processing by the machine learning model. If the size attribute of the image does not exceed the predefined spatial-metric threshold, then the tiling criterion is not satisfied, and the image can be processed as is by the machine learning model. In other words, a determination is made as to whether the machine learning model and system it is running upon including the memory resources would be able to handle processing of the image at the given size attribute. If it can't be handled, then the image is broken down into smaller pieces using the architecture-aware image tiling process disclosed herein and the tiles generated from that process are input into the machine learning model. Alternatively, if it can be handled then there is no need for the architecture-aware image tiling process and the image is simply used as direct input into the machine learning model.

At block 910, a tiling element for the image is generated. In some instances, the generating of the tiling element is performed in response to determining that the size attribute of the image exceeds the predefined spatial-metric threshold. The generating comprises: (i) determining a number of down-sampling iterations to be implemented in the machine learning model, (ii) determining a size of a kernel to be applied during convolution operations in the machine learning model, (iii) determining, for each level or each resolution, a number of convolutional layers being implemented by the machine learning model, or any combination thereof. The generating further comprises: generating a non-overlapping core region and an overlapping border region of the tiling element. The overlapping border region surrounds the non-overlapping core region, and a size of the non-overlapping core region is determined based on a dimension-reduction attribute N calculated from the number of down-sampling iterations, the size of the kernel, the number of convolutional layers, or any combination thereof. In some instances, the machine learning model is configured to include the convolutional layers at each of one or more resolutions, and each of the down-sampling iterations leads to a different resolution of an image version being assessed.

At block 915, tiles are extracted from the image using the tiling element. Each tile has the same non-overlapping core region and the same overlapping border region as the tiling element. Extracting the tiles from the image using the tiling element comprises: sliding the tiling element through the image until the tiling element traverses the entire image; and for each portion of the image that the tiling element is aligned as it slides through the image, a corresponding tile is extracted from the portion of the image, wherein each tile will have the same dimensions as the tiling element including the overlapping border region and the non-overlapping core region.

In some instances, as the tiling element slides through the image, the non-overlapping core regions of tiles being extracted from neighboring portions of the image are adjacent to one another but do not overlap with one another and the overlapping border regions of tiles being extracted from neighboring portions of the image do overlap with one another.

At block 920, each tile is input into the machine learning model.

At block 925, a convolved portion of the image is generated, for each tile, using at least convolutional layers, the kernel, and the down-sampling layers. The convolutional layers without padding or border treatment trim down each tile such that the non-overlapping core region is only used to generate each of the convolved portions of the image. In some instances, generating, for each tile, the convolved portion of the image, comprises: (i) sliding the kernel over the tile one step at a time; (ii) for each step, a center of the kernel is placed at a specific position on the tile; (iii) during the sliding process, values of the kernel are element-wise multiplied with corresponding values in a input region that the kernel covers on the tile to obtain results; (iv) summing the results of the element-wise multiplication are summed up to obtain a single value, wherein the single value represents output of the kernel at the specific position; and (v) repeating (i)-(iv) for every possible position where the kernel can fit on the tile. Each convolutional layer outputs a new feature map, and each element of the new feature map represents the output of applying the kernel to the specific position on the tile. No padding or border treatment is applied to each tile as it is convolved.

At block 930, a convolved version of the image is generated using the convolved portions of the image.

At block 935, the convolved version of the image is output.

At block 940, the machine learning model or another machine learning model detects, characterizes, classifies, or a combination thereof some or all regions or objects within the image using the convolved version of the image, and outputs an inference based on the detecting, characterizing, classifying, or a combination thereof.

At optional block 945, a diagnosis of a subject associated with the image or the convolved version of the image is determined based on the inference output by the machine learning model or another machine learning model.

At optional block 950, a treatment is administered to the subject associated with the image or the convolved version of the image. In some instances, the treatment is administered based on (i) inference output by the machine learning model or another machine learning model, and/or (ii) the diagnosis of the subject determined at block 945.

### V. Additional Considerations

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
accessing an image;
generating a tiling element for the image, wherein the generating the tiling element comprises:
determining a number of down-sampling layers to be implemented in a machine learning model that is to be used for processing the image;
determining a size of a kernel to be applied during convolution operations in the machine learning model; and
generating a non-overlapping core region and an overlapping border region of the tiling element, wherein the overlapping border region surrounds the non-overlapping core region and a size of the non-overlapping core region is determined based on a dimension-reduction attribute N calculated from the number of down-sampling iterations and the size of the kernel;
extracting tiles from the image using the tiling element, wherein each tile has the same non-overlapping core region and the same overlapping border region as the tiling element;
inputting each tile into the machine learning model;
generating, for each tile, a convolved portion of the image using at least convolutional layers, the kernel, and the down-sampling layers;
generating a convolved version of the image using the convolved portions of the image; and
outputting the convolved version of the image.

2. The computer-implemented method of claim 1, wherein:
the machine learning model is configured to include the convolutional layers at each of one or more resolutions;
each of the down-sampling iterations leads to a different resolution of an image version being assessed;
the generating the tiling element further comprises determining, for each level or each resolution, a number of convolutional layers being implemented by the machine learning model; and
the dimension-reduction attribute N is calculated from the number of down-sampling iterations, the size of the kernel, and number of convolutional layers.

3. The computer-implemented method of claim 2, wherein the convolutional layers without padding or border treatment trim down each tile such that the non-overlapping core region is only used to generate each of the convolved portions of the image.

4. The computer-implemented method of claim 1, wherein extracting the tiles from the image using the tiling element comprises:
sliding the tiling element through the image until the tiling element traverses the entire image; and
for each portion of the image that the tiling element is aligned as it slides through the image, a corresponding tile is extracted from the portion of the image, wherein each tile will have the same dimensions as the tiling element including the overlapping border region and the non-overlapping core region.

5. The computer-implemented method of claim 4, wherein as the tiling element slides through the image, the non-overlapping core regions of tiles being extracted from neighboring portions of the image are adjacent to one another but do not overlap with one another and the overlapping border regions of tiles being extracted from neighboring portions of the image do overlap with one another.

6. The computer-implemented method of claim 1, wherein generating, for each tile, the convolved portion of the image comprise:
(i) sliding the kernel over the tile one step at a time;
(ii) for each step, a center of the kernel is placed at a specific position on the tile;
(iii) during the sliding process, values of the kernel are element-wise multiplied with corresponding values in a input region that the kernel covers on the tile to obtain results;
(iv) summing the results of the element-wise multiplication are summed up to obtain a single value, wherein the single value represents output of the kernel at the specific position; and
(v) repeating (i)-(iv) for every possible position where the kernel can fit on the tile, wherein each convolutional layer outputs a new feature map, and wherein each element of the new feature map represents the output of applying the kernel to the specific position on the tile.

7. The computer-implemented method of claim 6, wherein no padding or border treatment is applied to each tile.

8. A system comprising:
one or more data processors; and
a non-transitory computer readable storage medium containing instructions which, when executed on the one or more data processors, cause the one or more data processors to perform a set of actions including:
accessing an image;
generating a tiling element for the image, wherein the generating the tiling element comprises:
determining a number of down-sampling layers to be implemented in a machine learning model that is to be used for processing the image;
determining a size of a kernel to be applied during convolution operations in the machine learning model; and
generating a non-overlapping core region and an overlapping border region of the tiling element, wherein the overlapping border region surrounds the non-overlapping core region and a size of the non-overlapping core region is determined based on a dimension-reduction attribute N calculated from the number of down-sampling iterations and the size of the kernel;
extracting tiles from the image using the tiling element, wherein each tile has the same non-overlapping core region and the same overlapping border region as the tiling element;
inputting each tile into the machine learning model;
generating, for each tile, a convolved portion of the image using at least convolutional layers, the kernel, and the down-sampling layers;
generating a convolved version of the image using the convolved portions of the image; and
outputting the convolved version of the image.

9. The system of claim 8, wherein:
the machine learning model is configured to include the convolutional layers at each of one or more resolutions;
each of the down-sampling iterations leads to a different resolution of an image version being assessed;
the generating the tiling element further comprises determining, for each level or each resolution, a number of convolutional layers being implemented by the machine learning model; and
the dimension-reduction attribute N is calculated from the number of down-sampling iterations, the size of the kernel, and number of convolutional layers.

10. The system of claim 9, wherein the convolutional layers without padding or border treatment trim down each tile such that the non-overlapping core region is only used to generate each of the convolved portions of the image.

11. The system of claim 8, wherein extracting the tiles from the image using the tiling element comprises:
sliding the tiling element through the image until the tiling element traverses the entire image; and
for each portion of the image that the tiling element is aligned as it slides through the image, a corresponding tile is extracted from the portion of the image, wherein each tile will have the same dimensions as the tiling element including the overlapping border region and the non-overlapping core region.

12. The system of claim 11, wherein as the tiling element slides through the image, the non-overlapping core regions of tiles being extracted from neighboring portions of the image are adjacent to one another but do not overlap with one another and the overlapping border regions of tiles being extracted from neighboring portions of the image do overlap with one another.

13. The system of claim 8, wherein generating, for each tile, the convolved portion of the image comprise:
(i) sliding the kernel over the tile one step at a time;
(ii) for each step, a center of the kernel is placed at a specific position on the tile;
(iii) during the sliding process, values of the kernel are element-wise multiplied with corresponding values in a input region that the kernel covers on the tile to obtain results;
(iv) summing the results of the element-wise multiplication are summed up to obtain a single value, wherein the single value represents output of the kernel at the specific position; and
(v) repeating (i)-(iv) for every possible position where the kernel can fit on the tile, wherein each convolutional layer outputs a new feature map, and wherein each element of the new feature map represents the output of applying the kernel to the specific position on the tile.

14. The system of claim 13, wherein no padding or border treatment is applied to each tile.

15. A computer-program product tangibly embodied in a non-transitory machine-readable storage medium, including instructions configured to cause one or more data processors to perform a set of actions including:
accessing an image;
generating a tiling element for the image, wherein the generating the tiling element comprises:
determining a number of down-sampling layers to be implemented in a machine learning model that is to be used for processing the image;
determining a size of a kernel to be applied during convolution operations in the machine learning model; and
generating a non-overlapping core region and an overlapping border region of the tiling element, wherein the overlapping border region surrounds the non-overlapping core region and a size of the non-overlapping core region is determined based on a dimension-reduction attribute N calculated from the number of down-sampling iterations and the size of the kernel;
extracting tiles from the image using the tiling element, wherein each tile has the same non-overlapping core region and the same overlapping border region as the tiling element;
inputting each tile into the machine learning model;
generating, for each tile, a convolved portion of the image using at least convolutional layers, the kernel, and the down-sampling layers;
generating a convolved version of the image using the convolved portions of the image; and
outputting the convolved version of the image.

16. The computer-program product of claim 15, wherein:
the machine learning model is configured to include the convolutional layers at each of one or more resolutions;
each of the down-sampling iterations leads to a different resolution of an image version being assessed;
the generating the tiling element further comprises determining, for each level or each resolution, a number of convolutional layers being implemented by the machine learning model; and
the dimension-reduction attribute N is calculated from the number of down-sampling iterations, the size of the kernel, and number of convolutional layers.

17. The computer-program product of claim 16, wherein the convolutional layers without padding or border treatment trim down each tile such that the non-overlapping core region is only used to generate each of the convolved portions of the image.

18. The computer-program product of claim 15, wherein extracting the tiles from the image using the tiling element comprises:
sliding the tiling element through the image until the tiling element traverses the entire image; and
for each portion of the image that the tiling element is aligned as it slides through the image, a corresponding tile is extracted from the portion of the image, wherein each tile will have the same dimensions as the tiling element including the overlapping border region and the non-overlapping core region.

19. The computer-program product of claim 18, wherein as the tiling element slides through the image, the non-overlapping core regions of tiles being extracted from neighboring portions of the image are adjacent to one another but do not overlap with one another and the overlapping border regions of tiles being extracted from neighboring portions of the image do overlap with one another.

20. The computer-program product of claim 15, wherein generating, for each tile, the convolved portion of the image comprise:
(i) sliding the kernel over the tile one step at a time;
(ii) for each step, a center of the kernel is placed at a specific position on the tile;
(iii) during the sliding process, values of the kernel are element-wise multiplied with corresponding values in a input region that the kernel covers on the tile to obtain results;
(iv) summing the results of the element-wise multiplication are summed up to obtain a single value, wherein the single value represents output of the kernel at the specific position; and
(v) repeating (i)-(iv) for every possible position where the kernel can fit on the tile, wherein each convolutional layer outputs a new feature map, and wherein each element of the new feature map represents the output of applying the kernel to the specific position on the tile.
